(19) United States
(12) Patent Application Publication
(10) Pub. No.: US 2008/0129632 A1
(43) Pub. Date: Jun. 5, 2008

(54) ANTENNA HAVING ADDITIONAL GROUND

(75) Inventors: Young-min MOON, Seoul (KR); Young-eil KIM, Suwon-si (KR); Se-hyun PARK, Suwon-si (KR); Kyeong-sik MIN, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/741,784

(22) Filed: Apr. 30, 2007

(30) Foreign Application Priority Data
Dec. 5, 2006 (KR) 10-2006-0122156

(51) Int. Cl. H01Q 1/48

(52) U.S. Cl. 343/848

(57) ABSTRACT

An antenna having an additional ground, includes a first ground which is formed in one side of a substrate; a plurality of antenna elements which are formed symmetrically with respect to each other and spaced apart from one end of the first ground; and a second ground which is interposed between the plurality of the antenna elements and integrally formed with the first ground. Accordingly, the deterioration of the antenna characteristics can be minimized even after the arrangement of the antenna elements with the ground, and the antenna can be miniaturized and easily fabricated in a two-dimensional structure. Furthermore, the electromagnetic wave interference can be minimized between the antenna elements.

### CROSS-REFERENCE TO RELATED APPLICATIONS

This application claims priority from Korean Patent Application No. 2006-122156 filed on Dec. 5, 2006 in the Korean Intellectual Property Office, the entire disclosure of which is incorporated herein by reference.

### BACKGROUND OF THE INVENTION

1. Field of the Invention

Methods consistent with the present invention relate to an antenna having an additional ground. More particularly, the present invention relates to an antenna having an additional ground, which can minimize antenna characteristic deterioration after arranging antenna elements with the ground, miniaturizing the antenna size, and minimizing electromagnetic wave interference between the antenna elements.

2. Description of the Related Art

In response to demands for high quality multimedia services using the wireless mobile communication technology, a next generation radio transmission technique is required to transfer more data at a higher rate with a lower error probability.

Hence, a multiple input multiple output (MIMO) antenna has been suggested. The MIMO antenna performs the MIMO operation by arranging a plurality of antenna elements in a special structure. The MIMO antenna enables to sharply form the overall radiation pattern and to further transfer the electromagnetic wave by combining radiation patterns and radiated powers of the antenna elements.

Therefore, it is possible to raise the data rate in a certain range or increase the system range at a specific data rate. The MIMO antenna, which is the next generation mobile communication technique widely applicable to mobile terminals and repeaters, is attracting attention as the new technique to overcome the restricted transmission amount of the mobile communication that has reached the limit due to the data communication extension.

However, the MIMO antenna requires smaller antenna elements to install the plurality of the antenna elements within a small terminal. Thus, it is very difficult to implement the MIMO antenna using the related art antennas. What is needed are small antenna elements capable of implementing the MIMO system in accordance with the miniaturization of the terminal.

To install the MIMO antenna in the small terminal, the interval between the antenna elements is inevitably narrow. In this case, the electromagnetic waves radiated from the antenna elements are subject to the interference. To address this problem, the suggested antennas mitigate the impedance matching and the electromagnetic wave interference by forming a slot between the antenna elements in a ground to which the plurality of the antenna elements are earthed. However, when the slots are formed in the ground, it may be hard to mount other components or the positions for mounting other components may be quite restricted.

Meanwhile, in the typical design of the MIMO antenna, the antenna elements are first designed and then arranged with the ground by taking into account the antenna characteristics. When the antenna is designed in that order, it is hard to retain the antenna characteristics after the arrangement with the ground.

This disadvantage is true for not only the MIMO antenna but an array antenna and dual or multiband antenna having a plurality of antenna elements.

### SUMMARY OF THE INVENTION

The present invention has been provided to address the above-mentioned and other problems and disadvantages occurring in the related art arrangement, and an aspect of the present invention is to provide an antenna having an additional ground for avoiding interference of electromagnetic waves radiated from antenna elements, freeing installation and design of components when mounted in a small device, and retaining antenna characteristics after arranging with the ground in the design of the antenna having a plurality of the antenna elements.

According to an aspect of the present invention, there is provided an antenna having an additional ground, which includes a first ground which is formed in one side of a substrate; a plurality of antenna elements which are spaced apart from one end of the first ground; and a second ground which is interposed between the plurality of the antenna elements and integrally formed with the first ground.

A feed point may be formed at an end of each of the antenna elements, the end facing the first ground.

An end of each of the antenna elements, facing the second ground, may be connected to the second ground to form a ground point.

The antenna elements each may include a first line which links the ground point to the feed point, and a second line having a meander line shape which extends from the ground point and bends zigzag several times in parallel with the first line.

The antenna elements each may include a first line which links the ground point to the feed point, and a second line having a meander line shape which extends from the ground point and bends zigzag several times in a width direction of the first line.

The antenna elements each may include a first line which links the ground point to the feed point, and a second line which extends from the ground point in a spiral shape.

The antenna elements each may include a first line which links the ground point to the feed point, and a second line which extends from the ground point in a spiral shape and bends zigzag several times in a meander line shape.

A radiation pattern of each of the antenna elements may be directionally opposite to the first ground.

A third ground may be formed on the other side of the substrate, the third ground being connected to the first ground and the second ground.

The plurality of antenna elements may exhibit symmetry with respect to each other.

### BRIEF DESCRIPTION OF THE DRAWING FIGURES

These and/or other aspects of the present invention will become more apparent and more readily appreciated from the following description of exemplary embodiments thereof, with reference to the accompanying drawings, in which:

FIG. 1 is a plane view of an antenna having an additional ground according to one embodiment of the present invention;

FIG. 2 is a plane view of surface current when the antenna of FIG. 1 operates;

FIG. 3 is a plane view of radiation patterns in the direction of the antenna plate of FIG. 1;

FIG. 4 is a graph showing a return loss when the antenna of FIG. 1 is not mounted to a terminal;

FIG. 5 is a graph showing return a loss when the antenna of FIG. 1 is mounted to a terminal;

FIG. 6A depicts radiation patterns in view of YZ plane when the antenna of FIG. 1 is equipped to the terminal;

FIG. 6B depicts radiation patterns in view of XZ plane when the antenna of FIG. 1 is equipped to the terminal;

FIG. 7 is a plane view of an antenna having an additional ground according to another embodiment of the present invention;

FIG. 8 is a plane view of an antenna having an additional ground according to yet another embodiment of the present invention; and

FIG. 9 is a plane view of an antenna having an additional ground according to still another embodiment of the present invention.

### DETAILED DESCRIPTION OF EXEMPLARY EMBODIMENTS

Certain exemplary embodiments of the present invention will now be described in greater detail with reference to the accompanying drawings.

In the following description, the same drawing reference numerals are used to refer to the same elements, even in different drawings. The matters defined in the following description, such as detailed construction and element descriptions, are provided as examples to assist in a comprehensive understanding of the invention. Also, well-known functions or constructions are not described in detail, since they would obscure the invention in unnecessary detail.

While a multiple input multiple output (MIMO) antenna is illustrated by way of example, the present invention is applicable to an array antenna and dual or multiband antenna having a plurality of antenna elements.

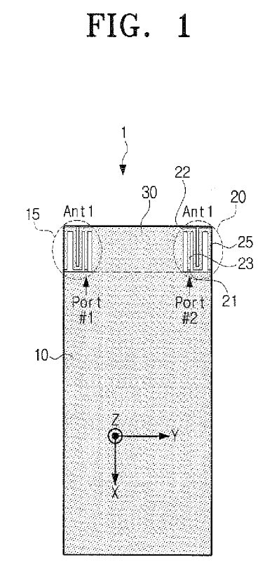

FIG. 1 is a plane view of an antenna having an additional ground according to one embodiment of the present invention.

The antenna 1 includes a first ground 10 formed in a side of a substrate, first and second antenna elements 15 and 20 arranged in the vicinity of one end of the first ground 10 and spaced apart from each other, and a second ground 30 formed between the first and second antenna elements 15 and 20.

The first ground 10 is formed to occupy almost one side of the substrate. In the side of the substrate, a mounting area is formed where the first ground 10 is not formed. Herein, the mounting area accommodates the first and second antenna elements 15 and 20 and the second ground 30 and occupies a very small portion of the entire substrate surface.

The first and second antenna elements 15 and 20 are disposed at the respective ends in the mounting area of the substrate such that they are spaced apart as far as possible from each other. The first and second antenna elements 15 and 20 are shaped in a symmetrical strip line. The operating frequency of the antenna 1 depends on the length of the strip line. Namely, the antenna 1 can be designed to operate in an intended operating frequency by forming the length of the strip line to ¼λ of the operating frequency.

The first and second antenna elements 15 and 20 have a feed point 21 formed in the vicinity of the first ground 10, and a ground point 22 formed at one end of the first and second antenna elements 15 and 20 in contact with the second ground 30.

In one embodiment of the present invention, the first and second antenna elements 15 and 20 are constructed with a first line 23 and a second line 25 being connected to each other. The first line 23 links the ground point 22 with the feed point 21 and is formed lengthwise in parallel to the second ground 30 in the vicinity of the second ground 30. The second line 25 extends from the ground point 22 of the first line 23 and forms a meander line such that its strip line in parallel with the first line 23 progresses widthwise to the first line 23 and bends zigzag several times.

The second ground 30, which is formed between the first and second antenna elements 15 and 20, is connected to the first and second antenna elements 15 and 20 and integrally formed with the first ground 10. As the second ground 30 is interposed between the first and second antenna elements 15 and 20, the radiation patterns from the first and second antenna elements 15 and 20 are generated in the symmetrical direction based on the second ground 30. Accordingly, since the interference of the radiation patterns from the first and second antenna elements 15 and 20 can be avoided, the electrical interference between the first and second antenna elements 15 and 20 is minimized. The second ground 30 forms a space for accommodating other components, to thus provide a sufficient space for installing a circuit, an LCD panel, a battery and so forth required for the terminal having the antenna 1, and allow for free spacing.

Unlike the related art, in the antenna 1, the first ground 10 suitable for the terminal is first designed and then the first and second antenna elements 15 and 20 are designed to match the operating frequency. Lastly, the second ground 30 is designed to avoid the interference with the first and second antenna elements 15 and 20. Hence, after arranging the antenna elements with the ground, the characteristic deterioration of the antenna 1 is minimized.

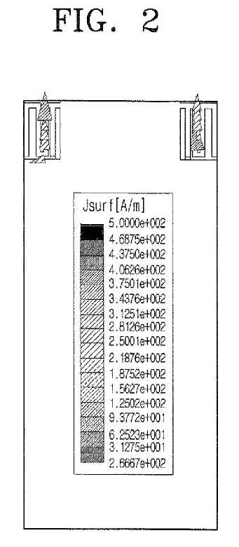

FIG. 2 is a plane view of a surface current when the antenna of FIG. 1 operates.

As shown in FIG. 2, the surface current is generated mostly around the first and second antenna elements 15 and 20 of the antenna 1, and little surface current is generated in the second ground 30. The surface current is generated only in the first and second antenna elements 15 and 20 because the second ground 30, which is interposed between the first and second antenna elements 15 and 20, serves as a reflector of the first and second antenna elements 15 and 20. As a result, the electromagnetic waves radiated from the first and second antenna elements 15 and 20 hardly suffer from the interference.

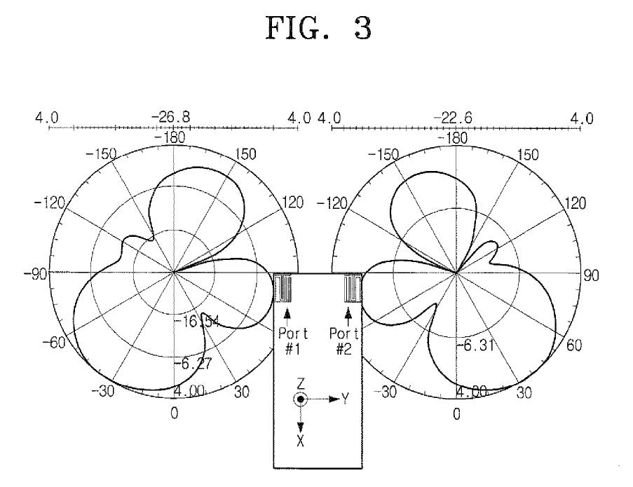

FIG. 3 is a plane view of radiation patterns in the direction of the antenna plate of FIG. 1.

In view of the substrate as the XY plane and the axis perpendicular to the substrate as the Z axis, the radiation patterns of the first and second antenna elements 15 and 20 are symmetrically generated. Hence, there is little mixing of the radiation patterns of the first and second antenna elements 15 and 20. Since the radiation patterns of the first and second antenna elements 15 and 20 have the null facing the first and second antenna elements 15 and 20, as one can see, the electromagnetic waves do not radiate toward the first and second antenna elements 15 and 20. Accordingly, the interference with other elements is trivial because the electromagnetic waves from the first and second antenna elements 15 and 20 do not affect the other components mounted in the substrate.

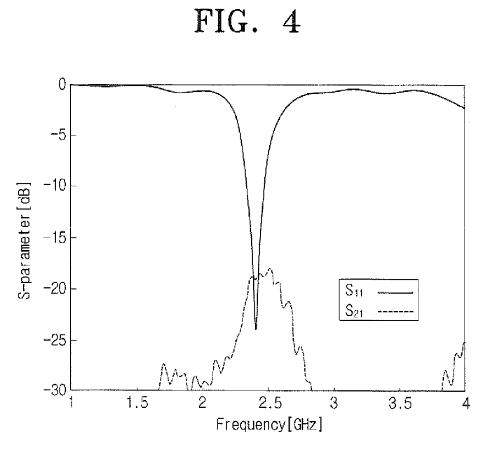

FIG. 4 is a graph showing a return loss without equipping the antenna of FIG. 1 to a terminal and, more particularly, shows results acquired by designing the first and second antenna elements 15 and 20 to operate in the WLAN band of 2.35 GHz.

According to an S11 parameter of the first and second antenna elements 15 and 20, the center frequency of the antenna 1 of FIG. 1 is generated at about the 2.5 GHz band and the bandwidth at −10 dB is about 150 MHz. The center frequency is higher than the target WLAN band and adjustable when mounting to the terminal. An S21 parameter of the first and second antenna elements 15 and 20 is −17.8 dB, which is quite good.

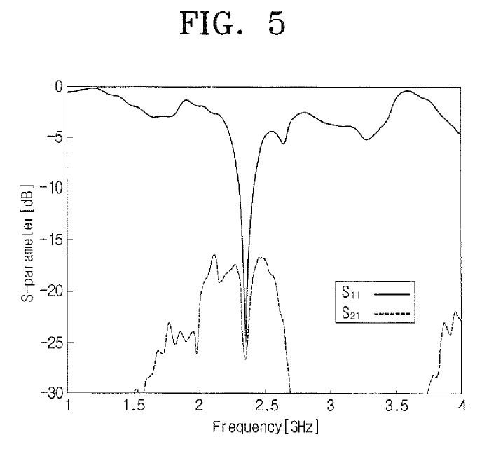

FIG. 5 is a graph showing a return loss with the antenna of FIG. 1 equipped to a terminal.

When the antenna 1 is mounted to the terminal, as one can see from the S11 parameter in FIG. 5, the antenna 1 operates in the center frequency at 2.35 GHz, that is, at the target frequency band. The bandwidth at −10 dB is about 150 MHz, and the S21 parameter is −27 dB at the center frequency and −17 dB over 2.3˜2.45 GHz band. Thus, it is noted that the antenna characteristics are more improved when the antenna 1 is mounted to the terminal.

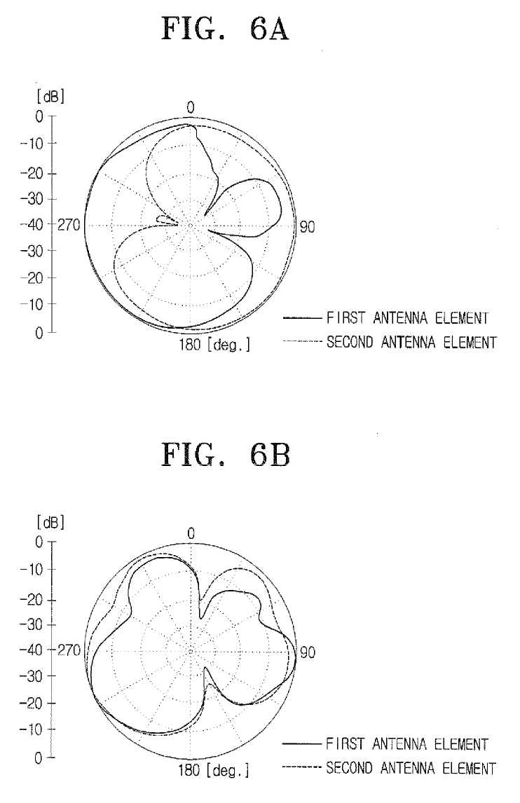

FIG. 6A depicts a radiation pattern in view of the YZ plane when the antenna of FIG. 1 is mounted to the terminal, and FIG. 6B depicts a radiation pattern in view of the XZ plane when the antenna of FIG. 1 is mounted to the terminal.

The radiation patterns of FIG. 6A are measured by setting the front of the terminal at 0 degrees, the direction of the second antenna element 20 at 90 degrees, the rear of the terminal at 180 degrees, and the direction of the first antenna element 15 at 270 degrees. The solid line indicates the radiation pattern on the first antenna element 15 and the dotted line indicates the radiation pattern on the second antenna element 20. As shown in FIG. 6A, the radiation patterns of the first and second antenna elements 15 and 20 are symmetrical, and the electromagnetic wave from the first antenna element 15 to the second antenna element 20 (i.e., the electromagnetic waves from 270 degrees to 90 degrees) and the electromagnetic waves from the second antenna element 20 to the first antenna element 15 (i.e., the electromagnetic waves from 90 degrees to 270 degrees) are even less than the electromagnetic waves facing to the front and the rear of the terminal. In brief, the electromagnetic waves generated in the first and second antenna elements 15 and 20 suffer less interference.

The radiation patterns of FIG. 6B are measured by setting the upside of the terminal at 0 degrees, the front of the terminal at 90 degrees, the bottom of the terminal at 180 degrees, and the rear of the terminal at 270 degrees. The solid line indicates the radiation pattern on the first antenna element 15 and the dotted line indicates the radiation pattern on the second antenna element 20. As shown in FIG. 6B, the electromagnetic waves radiated from the first antenna element 15 and the second antenna element 20 are similar to each other in quantity, and the amount of the electromagnetic waves radiated to the front of the terminal is greater than the amount of the electromagnetic waves radiated to the rear of the terminal.

As above, according to the radiation patterns measured by mounting the antenna 1 to the terminal, the gain of the antenna 1 ranges −1˜0.3 dBi.

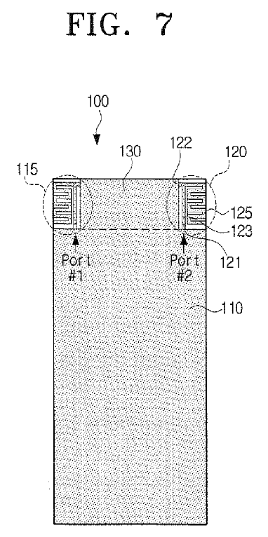

FIG. 7 is a plane view of an antenna having an additional ground according to another embodiment of the present invention.

The antenna 100 is constructed similar to the antenna 1, including a first ground 110, first and second antenna elements 115 and 120, and a second ground 130. The only difference lies in that the shapes of the first and second antenna elements 115 and 120 are different from those of the antenna 1.

The first and second antenna elements 115 and 120 include a first line 123 in parallel with the second ground 130 and a second line 125 in a shape of meander line. The first line 123 links a feed point 121 with a ground point 122 as in the one embodiment of FIG. 1 of the present invention. The second line 125 is connected to the ground point 122 of the first line 123 and formed as a meander line wherein a strip line formed widthwise along the first line 123 progresses in the longitudinal direction of the first line 123 and bends several times.

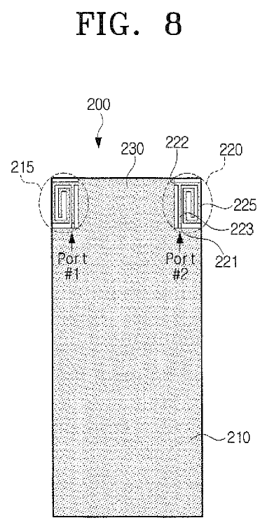

FIG. 8 is a plane view of an antenna having an additional ground according to yet another embodiment of the present invention.

First and second antenna elements 215 and 220 of the antenna 200 have different shapes as compared to the above embodiments of the present invention.

The first and second antenna elements 215 and 220 include a first line 223 in parallel with the second ground 230 and a second line 225. The second line 225, which is connected to a ground point 222, extends from the ground point 222 and bends several times in a spiral form. While the second line 225 of FIG. 8 is shaped in a rectangular spiral form, the second line 225 can be formed in various spiral shapes such as circular spiral, triangular spiral, and polygonal spiral.

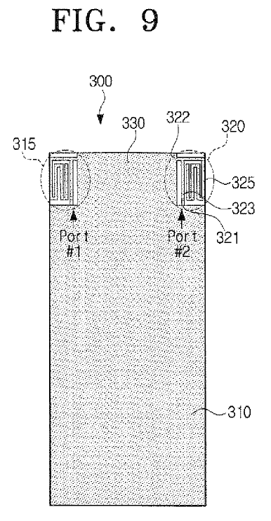

FIG. 9 is a plane view of an antenna having an additional ground according to still another embodiment of the present invention.

The antenna 300 includes first and second antenna elements 315 and 320 including a first line 323 and a second line 325. The first line 323 is formed in parallel with the second ground 330. The second line 325 is formed as a spiral shape which extends outward from the ground point 322 of the first line 323 and bends in parallel with the first line 323, and as a meander line of which a strip line parallel to the first line 323 bends several times from the spiral shape.

The antennas 100, 200, and 300 of FIGS. 7, 8, and 9 show substantially similar antenna characteristics and performance to the antenna 1 of FIG. 1. It should be understood that the shapes of the first and second antenna elements 15 and 20, 115 and 120, 215 and 220, and 315 and 320 can be altered.

As such, the antenna 1, 100, 200, and 300 having the additional ground can minimize the deterioration of the antenna characteristics even after the arrangement with the ground, and are suited to the terminal by designing the first ground 10 and 110 suitable for the terminal, designing the first and second antenna elements 15 and 20, 115 and 120, 215 and 220, and 315 and 320 according to the operating frequency, and then designing the second ground 30, 130, 230 and 330. By virtue of the first and second grounds (10, 110, 210, 310) and (30, 130, 230, and 330), the area of the ground can be increased. By designing the first and second antenna elements 15 and 20, 115 and 120, 215 and 220, and 315 and 320 in the meander line shape or the spiral shape, the antenna 1, 100, 200, and 300 can be miniaturized and easily fabricated in a two-dimensional structure.

The electromagnetic wave interference between the first antenna element 15, 115, 215, and 315 and the second antenna element 20, 120, 220, and 320 can be minimized by forming the second ground (30, 130, 230, 330) between the first antenna element 15, 115, 215, and 315 and the second antenna element 20, 120, 220, and 320. Also, on account of the less amount of the electromagnetic waves radiated from the first antenna element 15, 115, 215, and 315 and the second antenna element 20, 120, 220, and 320 to the substrate, the interference with the other components mounted in the substrate becomes trivial.

To enhance the antenna characteristics, a third ground may be formed on the other side of the substrate, opposite to the side where the first antenna element 15, 115, 215, and 315 and the second antenna element 20, 120, 220, and 320, and the first and second grounds (10, 110, 210, 310), and (30, 130, 230, 330) are formed. The third ground, which is connected to the first and second grounds 10 and 30, and 110 and 130, serves to increase the area of the entire ground.

In light of the foregoing, the deterioration of the antenna characteristics can be minimized even after the arrangement of the antenna elements and the ground, and the antenna can be miniaturized and easily fabricated in the two-dimensional structure. Furthermore, the electromagnetic wave interference can be minimized between the first antenna element and the second antenna element.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. An antenna comprising:
a first ground which is formed in one side of a substrate;
a plurality of antenna elements which are spaced apart from one end of the first ground; and
a second ground which is interposed between the plurality of the antenna elements and integrally formed with the first ground.

2. The antenna of claim 1, wherein a feed point is formed at an end of each of the antenna elements, the end facing the first ground.

3. The antenna of claim 2, wherein an end of each of the antenna elements, facing the second ground, is connected to the second ground to form a ground point.

4. The antenna of claim 3, wherein the antenna elements each comprises a first line which links the ground point to the feed point, and a second line having a meander line shape which extends from the ground point and bends zigzag several times in parallel with the first line.

5. The antenna of claim 3, wherein the antenna elements each comprises a first line which links the ground point to the feed point, and a second line having a meander line shape which extends from the ground point and bends zigzag several times in a width direction of the first line.

6. The antenna of claim 3, wherein the antenna elements each comprises a first line which links the ground point to the feed point, and a second line which extends from the ground point in a spiral shape.

7. The antenna of claim 3, wherein the antenna elements each comprises a first line which links the ground point to the feed point, and a second line which extends from the ground point in a spiral shape and bends zigzag several times in a meander line shape.

8. The antenna of claim 1, wherein a radiation pattern of each of the antenna elements is directionally opposite to the first ground.

9. The antenna of claim 1, wherein a third ground is formed on the other side of the substrate, the third ground being connected to the first ground and the second ground.

10. The antenna of claim 1, wherein the plurality of antenna elements exhibit symmetry with respect to each other.
